(19) United States
(12) Patent Application Publication
(10) Pub. No.: US 2021/0180799 A1
(43) Pub. Date: Jun. 17, 2021

(54) System for and Method of Measuring Custom Fit Stove Top Covers

(71) Applicant: Matthew McCarthy, Parma, OH (US)

(72) Inventor: Matthew McCarthy, Parma, OH (US)

(21) Appl. No.: 16/914,284

(22) Filed: Jun. 27, 2020

Related U.S. Application Data
(63) Continuation-in-part of application No. 16/428,140, filed on May 31, 2019.
(60) Provisional application No. 62/679,523, filed on Jun. 1, 2018.

(51) Int. Cl. F24C 15/30; F24C 15/10; F24C 3/08; G01B 3/1061; G01B 5/02; G06Q 30/06

(52) U.S. Cl. CPC F24C 15/30; F24C 15/10; G06Q 30/0621; G01B 3/1061; G01B 5/02; F24C 3/082

(57) ABSTRACT

A stove top cover for a stove is described herein. The stove top cover can include a top surface and a bottom surface. The stove top can further include a cutout extending through the top surface and the bottom surface having a periphery that defines the cutout. Still further, the stove top cover can include a flange formed on the top surface that extends around the periphery of the cutout and projects outwardly from the top surface to a height and extends inwardly a distance toward an edge of a burner of the stove top. A method for providing the sizing and manufacture of the stove top cover provides for its customization to an individual user's stove top. The stove top cover included cutout extending around the periphery of the stove top, and forms individual orifices sized and positioned to accommodate each individual burner of the stove top.

### RELATED APPLICATIONS

This application is a Continuation in Part of U.S. patent application Ser. No. 16/428140, filed on May 31, 2019 and claims the benefit of U.S. Provisional Patent Application No. 62/679,523 filed on Jun. 1, 2018, entitled “Stove Top Cover,” the contents of both are incorporated herein in their entirety.

### BACKGROUND OF THE INVENTION

### 1. Field of the Invention

The present invention relates generally to stove top covers and, more particularly, to a system for and method of measuring for a custom fit stove top cover.

### 2. Description of the Related Art

When cooking a food or a liquid on a stove top, spills, leaks, drips, and the like are inevitable. The food or the liquid can fall onto a burner, get trapped under a grate, travel to other portions of the stove top, or migrate from the stove top onto other portions of a kitchen such as a countertop, a cabinet, or a floor. The food or the liquid can cause various issues, such as burdensome cleanup, staining, and contamination. Furthermore, upon use of the stove top, the surface of the stove top can become extremely hot causing injury to a person in proximity or in contact with the stove top, or damage to objects placed on or around the stove top.

As indicated in the Related Art, a cover is provided which is configured to engage a stove top which comprises a top surface, a bottom surface, and a border coupled to the top surface that extends around an outer perimeter of the cover and projects outwardly from the top surface. Such a cover comprises a cutout extending through the top surface and the bottom surface having a periphery that defines the cutout, wherein the cutout is configured to surround a burner of the stove top. Further included is a flange coupled to the top surface that extends around the periphery of the cutout and projects outwardly from the top surface to a height and extends inwardly a distance toward an edge of a burner of the stove top. In an alternate configuration of the stop top cover of the Related Art, the flange coupled to the top surface that extends around the periphery of the cutout and projects outwardly from the top surface to a height and extends inwardly a distance toward an edge of a burner of the stove top, wherein the distance the flange extends inwardly is such that the flange covers a portion of the burner.

In any configuration, such stove top covers function best when sized to be fittingly installed to a particular stove top. However, many stove configurations exist or may exist in the future such that it may be difficult for a stove owner to identify a properly sized cover for their individual stove top. Consequently, a need exists for a system for and method of to allow for the easy measuring of a stove top for purposes of providing a selected configuration stove top cover or a custom fit stove top cover.

### SUMMARY OF THE INVENTION

It is thus an object of the present invention to provide a system for measuring custom fit stove top covers.

It is another object of the present invention to provide a method for measuring custom fit stove top covers.

It is a feature of the present invention to provide a measuring kit and measuring guide to allow for the measuring of a stove top for identifying a custom fit stove top cover.

Briefly described according to the preferred embodiment of the present invention, a method for providing the sizing and manufacture of a stove top cover for a stove is described herein that is customized to an individual user's stove top. The stove top cover included cutout extending around the periphery of the stove top, and forms individual orifices sized and positioned to accommodate each individual burner of the stove top.

It is an advantage of the present invention to facilitate the easy identification and specification of a user's stove top in order to provide a custom fit stove top cover.

Further objects, features, elements and advantages of the invention will become apparent in the course of the following description.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 depicts an example of a perspective view of a stove top cover;

FIG. 2 depicts an example of a further perspective view of a stove top cover;

FIG. 3 depicts a first embodiment of a measuring kit 200 for use in a system for and method of measuring custom fit stove top covers according to the preferred embodiment of the present invention;

FIG. 4 depicts a measuring proof 300 for use in a system for and method of measuring custom fit stove top covers according to the preferred embodiment of the present invention;

FIG. 5 is a pictorial representation of STEP 1 of a method for measuring custom fit stove top covers according to the preferred embodiment of the present invention;

FIG. 6a is a pictorial representation of STEP 2 thereof;

FIG. 6b is a pictorial representation of STEP 2 thereof shown with an ALTERNATE form factor of stove cook top 206b;

FIG. 7 is a pictorial representation of STEP 3 thereof;

FIG. 8 is a pictorial representation of STEP 4 thereof;

FIG. 9 s a pictorial representation of STEP 5 thereof;

FIG. 10 s a pictorial representation of STEP 6 thereof;

FIG. 11 is a pictorial representation of STEP 7 thereof;

FIG. 12 is a pictorial representation of STEP 8 thereof;

FIG. 13 is a pictorial representation of STEP 9 thereof;

FIG. 14 is a pictorial representation of STEP 10 thereof;

FIG. 15 is a pictorial representation of STEP 11 thereof;

FIG. 16 is a pictorial representation of STEP 12 thereof;

FIG. 17 is a pictorial representation of STEP 13 thereof;

FIG. 18 is a pictorial representation of STEP 14 thereof;

FIG. 19 is a pictorial representation of STEP 15 thereof;

FIG. 20 is a pictorial representation of STEP 16 thereof;

FIG. 21 is a pictorial representation of STEP 17 thereof; and

FIG. 22 is a pictorial representation of STEP 18 thereof.

### DESCRIPTION OF THE PREFERRED EMBODIMENTS

The best mode for carrying out the invention is presented in terms of its preferred embodiment, herein depicted within the Figures. It should be understood that the legal scope of the description is defined by the words of the claims set forth at the end of this patent and that the detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112(f).

The best mode for carrying out the invention is presented in terms of its preferred embodiment, herein depicted within the Figures.

### 1. Detailed Description of the Figures

Before explaining the present invention in detail, it is important to understand that the invention is not limited in its application to the details of the construction illustrated and the steps described herein. The invention is capable of other embodiments and of being practiced or carried out in a variety of ways. It is to be understood that the phraseology and terminology employed herein is for the purpose of description and not of limitation.

The structures illustrated in the drawings include examples of the elements recited in the claims. The illustrated structures thus include examples of how a person of ordinary skill in the art can make and use the claimed invention. These examples are described to meet the enablement and best mode requirements of the patent statue without imposing limitations that are not recited in the claims. One or more of the elements of one embodiment may be used in combination with, or as a substitute for, one or more elements of another as needed for any particular implementation of the examples described herein.

The disclosure generally relates to a stove top cover. In some examples, the stove top cover can be constructed of one or more formable materials having one or more properties. The one or more materials can include, but are not limited to, fire retardant materials, fire resistant materials, heat resistant materials, wear resistant materials, scratch resistant materials, non-adhering materials, stain resistant materials, non-permeable materials, rigid materials, and elastic materials. The stove top cover can include a base, which can be fabricated to be geometrically and dimensionally commensurate with a stove top, wherein the stove top can include, but is not limited to, a gas stove top, an electric stove top and an induction stove top. In some examples, the stove top cover can further include one or more cutouts through which at least a portion of a burner of a stove can extend.

In an example, a portion of the base surrounding the one or more cutouts can be substantially fabricated of one or more of the fire retardant materials, the fire resistant materials, and the heat resistant materials to define a fire and heat adverse band. In other examples, one or more remaining portions of the base can be fabricated of the one or more of fire retardant materials, fire resistant materials, and heat resistant materials. The stove top cover can further include a border to help shield an outer rim of the stove top from adulteration and to aid in retaining food and/or liquid within the boundaries of the stove top cover.

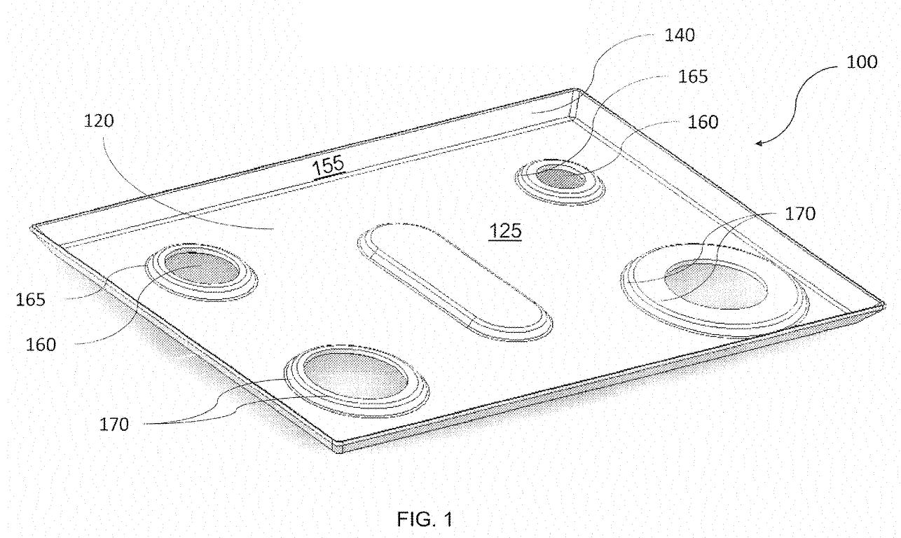

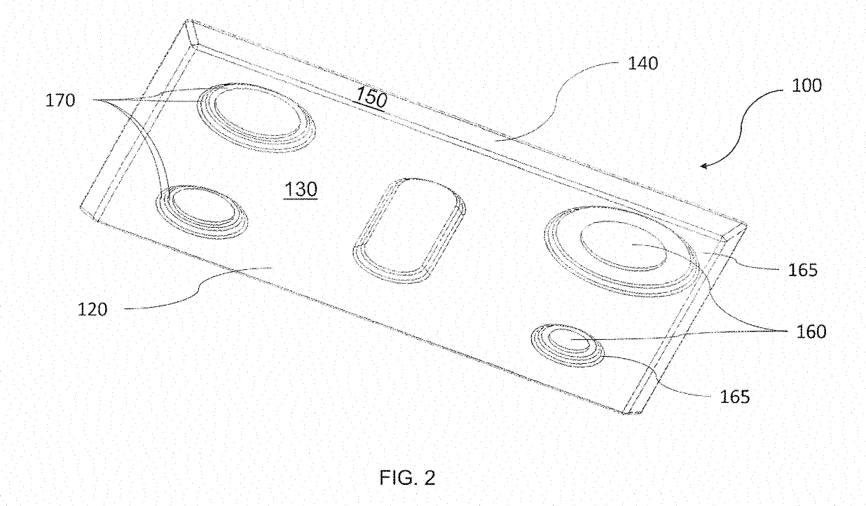

FIGS. 1 and 2 depict an example of a stove top cover 100. The stove top cover 100 can be configured to couple with a surface of a stove top. The stove top can include, but is not limited to, a gas stove top, an electric stove top, and an induction stove top having one or a plurality of burners.

The stove top cover 100 can be fabricated of one or one formable material having one or more properties. The one or more properties of the materials can include, but are not limited to, fire retardation, fire resistance, heat resistance, wear resistance, scratch resistance, adhering resistance, stain resistance, non-permeability, rigidity, and elasticity. As such, the stove top cover 100 can be fabricated to include, but is not limited to, one or more of fire retardant materials, fire resistant materials, heat resistant materials, wear resistant materials, scratch resistant materials, non-adhering materials, stain resistant materials, non-permeable materials, rigid materials, and elastic materials. In an example, the stove top cover 100 can be fabricated to include one or more of silicon, polyvinyl fluoride, Teflon coated fiberglass, and aluminum.

By fabricating the stove top cover 100 from the one or more materials described herein, the stove top cover 100 has particular advantages over existing stove top covers. For example, when the stove top cover 100 is placed on the surface of the stove top, the stove top cover 100 will not become excessively hot and/or damaged, e.g., from an open flame or other heat produced by the burner or radiating from the stove top. Thus, the stove top cover 100 can provide safe surface conditions to help prevent or reduce the opportunity for burns or other high-temperature affiliated injuries to a person in contact or in proximity to the stove top, or damage to objects in contact or in proximity to the stove top. As an example, the stove top cover 100 can provide space for food preparation such that food, cookware, dishes and the like can rest on the stove top cover 100 without melting, burning, or otherwise becoming damaged from heat produced by the stove top. Similarly, as the stove top cover 100 is scratch-resistant, blades can be used on the stove top cover 100 to cut, slice or any other manner of dissecting food without damaging the stove top cover 100. Even further, in some examples, the stove top cover 100 can help slow or stop the spread of fire such as in the occurrence of a kitchen fire.

In another example, the stove top cover 100 can provide surface conditions that simplify cleaning of the stove top cover 100 by preventing boiling, solidification, baking, congealing, scorching, hardening or adhering of food or liquid on the stove top cover 100. In other examples, the stove top cover 100 is stain resistant such that food and liquids generally do not cause discoloration of the stove top cover 100. In an even further example, the stove top cover 100 is impermeable such that any food or liquid cannot seep through to the surface of the stove top.

The stove top cover 100 can include a base 120. The base 120 can include a top surface 125, a bottom surface 130 that directly opposes the top surface 125 and an outer perimeter 135. The base 120 can cover the surface of the stove top to provide a barrier against adulteration, such as food or liquids. In other examples, the base 120 can function as a shield and protect the surface of the stove top from scratches, wear, and other adverse effects that can be caused by persons and the surrounding environment. The outer perimeter 135 can define an outer boundary of the base 120.

In an example, the base 120 can be fabricated to be geometrically and dimensionally commensurate with a geometry (e.g., a polygon, an ellipse, a customized geometry, an amorphous geometry, etc.) and dimensions of the surface of the stove top. In other examples, the base 120 can be of any geometry and any dimensions, irrespective Of the geometry and dimensions of the surface of the stove top. For example, the base 120 can be constructed to correspond to a geometry and dimensions of a single burner of the stove top in the event the single burner alone is used for cooking. In another example, the base 120 can be fabricated to correspond to a geometry and dimensions of a half of the stove top or any other portion of the stove top. In an even further example, the base 120 can be constructed to have any geometry and dimensions, notwithstanding the geometry and dimensions of a burner or a portion of the stove top.

In some examples, the base 120 can be fabricated as a unitary piece. In other examples, the base 120 can be constructed to include a plurality of pieces. In examples where the base 120 includes a plurality of pieces, each piece can include a plurality of perimeter edges that can define a geometry and dimensions of the piece. Each of the plurality of pieces can include one or more coupling mechanisms disposed on one or more of the perimeter edges. The coupling mechanisms can include, but are not limited to, magnets, snap fit joints, including annular, cantilever, or torsional snap fit joints, mechanical fasteners, mounting bosses, lips and grooves, pins, and the like. The coupling mechanisms of one piece can be configured to couple to the coupling mechanisms of adjacent pieces to partially or cumulatively form the base 120. In an example where the plurality of pieces utilize snap fit joints, the plurality of pieces can have sufficient stiffness, such as through material composition or material thickness, to achieve snap fitting. The plurality of pieces can be coupled together such that a seal can be created between each of the plurality of pieces, making the stove top cover 100 one of airtight and substantially airtight, such that any liquid or food is precluded from pervading and/or seeping through the base 120 to the surface and/or burner of the stove top when the stove top cover 100 is in use.

The base 120 can further include an opening (not shown in FIGS. 1 and 2). The opening can include one of a vent, a channel and a passageway. The opening can provide a pathway for heat and/or moisture generated by the stove top to the surrounding environment while covering the stove top. In other examples, where the surface of the stove top includes paint, the opening can prevent heat and/or moisture produced by the stove top from causing the paint to peel, crack, or lift away from the stove top while the base 120 is covering the stove top.

The base 120 can further include a reservoir (not shown in FIGS. 1 and 2). in some examples, the base 120 can include a single reservoir. In other examples, the base 120 can include a plurality of reservoirs. The reservoir can be located on the top surface 125 of the base 120. In some examples, the reservoir can be located at any location on the top surface 125 of the base. In other examples, the reservoir can be oriented to surround at least one of a cutout 160 of the base 120. Each reservoir can project downwardly from the top surface 125 toward the bottom surface 130 of the base 120, creating an indentation on the top surface 125 for capturing and containing liquids and food. The top surface 125 of the base 120 can include a gradient to direct liquids to the reservoir. Each reservoir can be shaped as a trench, a pit, or have any topography suitable for capturing and containing liquids.

The base 120 can further include a cutout 160. FIGS. 1 and 2 illustrate a stove top cover 100 having four cutouts 160 in the base 120. However, the base 120 can include one of a single cutout 160 and a plurality of cutouts 160. The cutout 160 can extend through the top surface 125 and the bottom surface 130 of the base 120 to create a hole in the base 120. The cutout 160 can include a periphery 165 that can define a geometry and dimensions of the cutout 160. A position of the cutout 160 on the base 120 can correspond to a position of a burner of the stove top. In examples having a plurality of cutouts 160, a position of each of the plurality of cutouts 160 on the base 120 can correspond to one of a plurality of burners on a stove top.

In some examples, where the stove top includes a gas stove top, the geometry and dimensions of the cutout 160 can be commensurate with a geometry and dimensions of a burner of the gas stove top, such that the cutout 160 can encompass a burner, yet permit the burner to extend through the cutout 160 and properly function. In other examples, where the stove top includes an electric stove top having one or more burners including coils, the geometry and dimensions of the cutout 160 can be commensurate with a geometry and dimensions of a burner of the electric stove top, such that the cutout 160 can encompass the burner, yet permit the burner to extend through the cutout 160 and properly function. In even further examples, where the stove top includes an induction stove top, the geometry and dimensions of the cutout 160 can be commensurate with a geometry and dimensions of a burner of the induction stove top, such that the cutout 160 can encompass the burner, yet permit the burner to extend through the cutout 160 and properly function. In any of the foregoing examples, the cutout 160 can be any geometry and any dimensions regardless of the geometry and dimensions of the burner, however, such that it does not interfere with function of the burner. The geometry of the cutout 160 can include, but is not limited to, a polygon, an ellipse, a customized geometry or an amorphous geometry.

In some examples, the base 120 can include a flange 170 coupled to a portion of the top surface 125 encompassing the cutout 160. In other examples, the base 120 can include a plurality of flanges 170, wherein each flange 170 is coupled to a portion of the top surface 125 encompassing one cutout 160.

Specifically, the flange 170 can extend around the periphery 165 of the cutout 160, and project upwardly (i.e. project perpendicularly or at an angle) from the top surface 125 to a height. Subsequently, the flange 170 can extend inwardly (i.e., so as to decrease a diameter of an aperture created by the flange 170) a distance toward an edge of a burner of a stove top, creating a lip of the flange. In one example, the flange 170 can extend inwardly so as to leave a peripheral gap around a cap or a coil of the burner so as to not interfere with a flame or heat produced by the burner. In another example, the flange 170 can extend inwardly so as to partially or substantially enclose and/or cover a portion of a burner, yet not interfere with a flame or heat produced by the burner. The flange 170 can provide greater coverage of the surface of the stove top for enhanced protection of the stove top from adulteration and to further help prevent heat-related injuries and damage to a person or an object.

In further examples, the cutout 160 can include a plurality of flanges 170. In one example, a second flange 170 can extend around a top surface of the flange 170 and project outwardly from the top surface of the flange 170 to a second height and extend inwardly a second distance (creating a second lip) toward the edge of the burner or cover the burner as described above. In another example, a third flange 170 can extend around a top surface of the second flange 170 and project outwardly from the top surface of the second flange 170 to a third height and extend inwardly a third distance (creating a third lip) toward the edge of the burner or cover the burner as described above.

In some examples, the flange 170 or plurality of flanges 170 can be formed as part of the base 120, such as by molding the base 120 and the flange 170 or plurality of flanges 170 together through injection molding, thermoforming, or any other appropriate molding technique. In other examples, the flange 170 or plurality of flanges 170 can be collectively fabricated as discrete pieces from the base 120, each having a perimeter edge including one or more coupling mechanisms disposed on the perimeter edge so as to couple with one or more coupling mechanisms of the base 120 or to other flanges 170. The coupling mechanisms can include, but are not limited to, magnets, magnets, snap fit joints, including annular, cantilever, or torsional snap fit joints, mechanical fasteners, mounting bosses, lips and grooves and pins. In an example of the flange 170, or the plurality of flanges 170, and the base 120 utilizing snap fit joints, each can have sufficient stiffness, such as through material composition or material thickness, to achieve snap fitting.

The stove top cover 100 can further include a border 140. The border 140 can be coupled to the outer perimeter 135 of the top surface 125 of the base 120, encasing the base 120. Further, the border 140 can project outwardly from the top surface 125 of the base 120. As such, the border 140 can help contain liquids and/or foods within the outer perimeter 135 of the base 120. For example, if a large volume of food and/or liquid spills onto the base 120, the border 140 can aid in prohibiting the food and/or liquid from going outside or underneath the stove top cover 100, thereby shielding the top surface and/or burner of the stove top from adulteration. In some examples, the border 140 can be free-standing, meaning that because a stove top is convex rather than concave, the border 140 is rigid enough to remain erect without the support of an outside rim of the stove top. In other examples, the border 140 can include an outside surface 150 that couples to a surface of an outside rim of the stove top. The outside surface 150 of the border 140 can overlay the surface of the outside rim of the stove top. Further, the border 140 can include an inside surface 155 that directly opposes the outside surface and faces toward the stove top.

In some examples, the border 140 can be fabricated to be geometrically and dimensionally commensurate with a geometry and dimensions of one of an outer perimeter (i.e., a convex stove top) and an outside rim (i.e., a concave stove top) of a stove top. For instance, the border 140 can have a height defined as a distance from the top surface 125 of the base 120 to an outermost point of the border 140. In some examples, the height of the border 140 can be one of commensurate with a height of the outside rim of the stove top or greater than or less than the height of the outside rim of the stove top. In other examples, the border 140 can be any geometry and any dimensions regardless of the geometry and dimensions of the outer perimeter or outside rim of the stove top.

In examples where the border 140 projects outwardly from the top surface 125 of the base 120, the border 140 can project at a 90 degree angle relative to the top surface 125. In another example, the border 140 can project outwardly from the top surface 125 at an angle commensurate with an angle of the surface of the outside rim of the stove top. In a further example, the border 140 can project outwardly from the top surface 125 at any angle relative to the top surface 125. In an even further example, the angle at which the border 140 can project outwardly from the top surface 125 of the base 120 can be adjustable to accommodate a user's needs or another stove top.

In some examples, the border 140 can include sides and corners. A side of the border 140 can correspond to a side of the base 120. A corner of the border 140 can correspond to a corner of the base 120. The corners of the border 140 can include a shape, defining a contour of the corner, including but not limited to, a geometry that is square, chamfered, beveled, filleted, or angled. Each corner can have a same or a different contour relative to any other corner.

In an example, the border 140 can be fabricated as a unitary piece. In another example, the border 140 can be fabricated to include a plurality of pieces. Where the border 140 includes a plurality of pieces, the border 140 can include discrete corners and side pieces. The plurality of pieces can be coupled together to form the border 140. Each of the plurality of pieces can include one or more coupling mechanisms for coupling the plurality of pieces together to form the border 140. The coupling mechanisms can include, but are not limited to, snap fit joints, including annular, cantilever, or torsional snap fit joints, mechanical fasteners, mounting bosses, lips, grooves, and pins. The coupling mechanisms of one piece can be configured to couple to the coupling mechanisms of adjacent pieces to partially or cumulatively form the border 140. In an example where the plurality of pieces utilize snap fit joints, the plurality of pieces can have sufficient stiffness, such as through material composition or material thickness, to achieve snap fitting. In a further example, the border 140 can be formed as part of the base 120, such as by molding the base 120 and the border 140 together through injection molding, thermoforming or any other suitable molding technique.

In some examples, the base 120 and/or the border 140 described herein can be formed from a single material layer or a plurality of material layers. In an example, the base 120 can include a single material layer, which can include the top surface 125 and the bottom surface 130. In another example, the base 120 can include a plurality of material layers where a first material layer can include the top surface 125 and a second material layer can include the bottom surface 130. In a further example, the base 120 can include a plurality of material layers where a first material layer can include the top surface 125, a second material layer can include the bottom surface 130, and one or more intermediate material layers can be oriented between the first and the second material layers.

Referring to the border 140, in an example, the border 140 can include a single material layer, which can include the outside surface 150 and the inside surface 155. In another example, the border 140 can include a plurality of material layers where a first material layer can include the outside surface 150 and a second material layer can include the inside surface 155. In a further example, the border 140 can include the plurality of material layers where a first material layer that can include the outside surface 150, a second material layer can include the inside surface 155 and one or more intermediate materials layers can be oriented between the first and the second materials layers. In examples where the base 120 and/or the border 140 includes a plurality of material layers, the material layers can be coupled together by any process or technique appropriate and effective for coupling the materials.

In some examples, where the base 120 and/or the border 140 includes a plurality of layers, each layer can include one or more of a fire retardant material, a fire resistant material, a heat resistant material, a non-permeable material, a wear resistant material, a scratch-resistant material, a non-adhering material, a stain resistant material, a rigid material, and an elastic material. In an example, a degree of a fire retardation, fire resistance, heat resistance, non-permeability, durability, non-adhesion, stain-resistance, rigidity, and elasticity of each layer can vary relative to each other. In another example, a degree of the foregoing properties of each layer can be substantially the same relative to each other. In a further example, a degree of the aforementioned properties of some layers can be substantially the same, while the degrees of such properties of other layers can vary.

In some examples, where the base 120 and/or the border 140 include a plurality of layers, the plurality of layers can have substantially similar thicknesses. Additionally, or alternatively, in some examples, the plurality of layers can have thicknesses that can vary relative to each other.

More specifically, FIGS. 1 and 2 show an example of the stove top cover 100 in a first condition. In the first condition, the stove top cover 100 can be releasably coupled to the surface of the stove top, such that the stove top cover 100 can be easily and efficiently removed from the surface of the stove top when desired. In some examples, the bottom surface 130 of the stove top cover 100 can overlay the top surface of the stove, and the outside surface 150 of the border 140 can overlay the surface of the outside rim of the surface of the stove top. The stove top cover 100 can contour and conform to a topography of the surface and the burners of the stove top. In some examples, a position of the stove top cover 100 on the top surface of the stove can be maintained via coupling mechanisms coupled to the stove top cover 100 along the bottom surface 130 of the base 120 and the outside surface 150 of the border 140. The coupling mechanisms can include, but are not limited to, magnets, elastics, adhering materials, and/or any other mechanism suitable for maintaining the position of the stove top cover 100.

Alternatively, the stove top cover 100 can be arranged in a second condition (not shown). In the second condition, the stove top cover 100 can be rolled compactly in any direction. In another example, the stove top cover 100 can also be folded compactly as desired. The stove top cover 100 can include a means for retaining the second condition including, but not limited to, magnets, fasteners, Velcro®, and clasps. The second condition can be useful to store, transport, or clean the stove top cover 100 or any other purpose. Generally, the stove top cover 100 is washable, portable and reusable as needed.

Furthermore, where the stove top cover 100 includes a plurality of pieces, the stove top cover 100 can be arranged in a third condition (not shown). In the third condition, the stove top cover 100 can be partially or completely assembled or disassembled. In some examples, the third condition can be suitable for cleaning, dishwashing, transporting, storing, or any other purpose.

2. Operation of the Preferred Embodiment

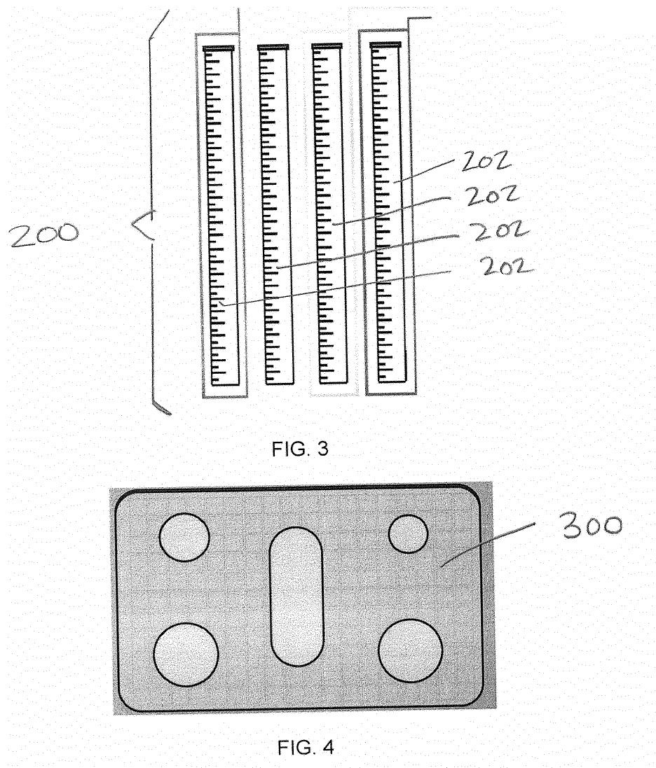

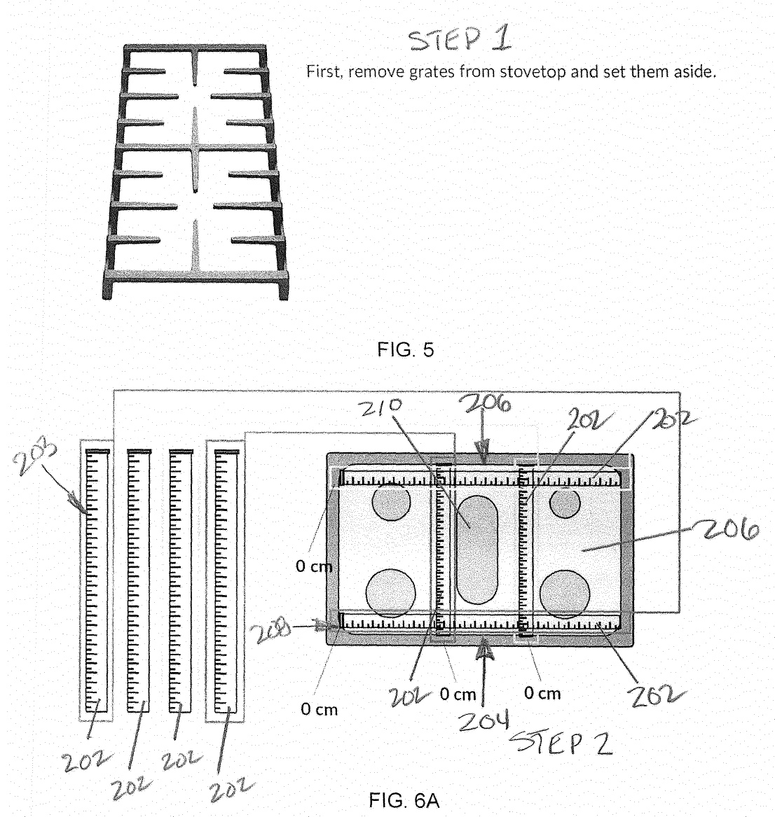

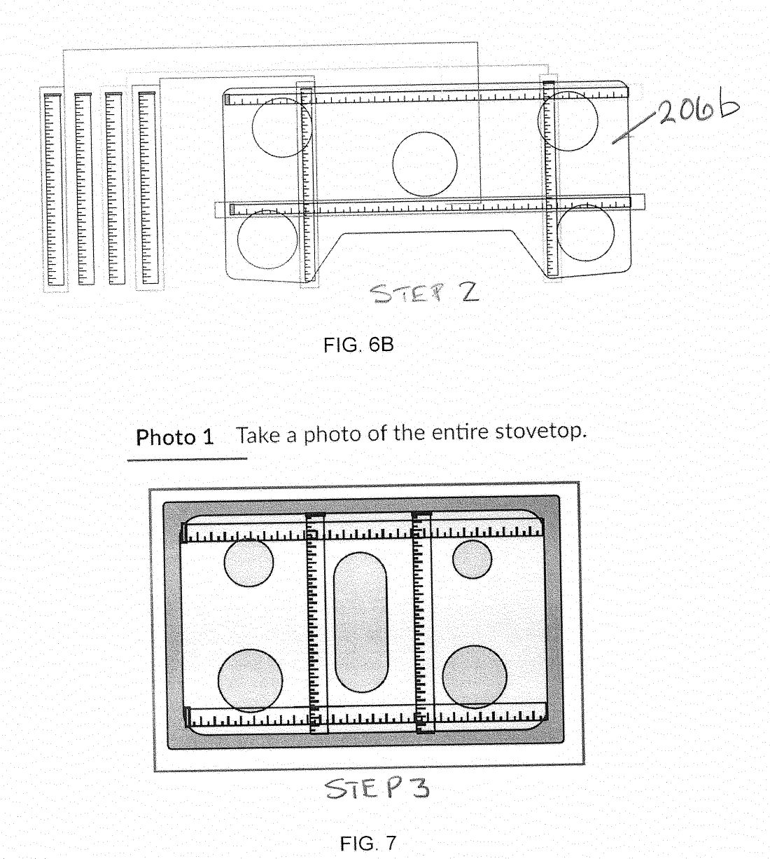

In operation, the stove top cover 100 must first be sized for form fitting or custom fitting to an individual's specific stove top. As shown in FIG. 3, a measuring kit 200 is shown use in a system for and method of measuring custom fit stove top covers according to the preferred embodiment of the present invention. Such a kit 200 includes a set of four (4) flexible measuring tapes 202. The kit 200 is thereby utilized with a method for measuring custom fit stove top covers. Shown in conjunction with FIG. 5, STEP 1 of the method for measuring custom fit stove top covers according to the preferred embodiment of the present invention requires removal of any grates from the stove top in order to prevent obstruction to the stove upper surface. Referring to FIG. 6a, the measuring tapes 202 are positioned about the stove upper surface 206 as shown in STEP 2, with a flexible measuring tape 202 placed laterally about the surface near a proximal edge 204 and a distal edge 206, with the remaining two flexible measuring tapes 202 positioned perpendicular to the proximal and distal edges 204, 206 respectively in a parallel manner bounding any center burner area 210. The flexible measuring tapes 202 are positioned flat with the measuring indicia 203 are face up, with zero point of the positioned along the left edge 208 for the proximal and distal edges and the zero point positioned along the proximal edge for the perpendicular tapes. It may be preferred for the measuring tapes 202 to be laid as flat as possible. Further, if any measuring tape is too long is may be trimmed with a scissors to fit.

Referring now to FIG. 6b, the positioning of the tape measures of STEP 2 is shown in an alternate method as shown for cook top configuration.

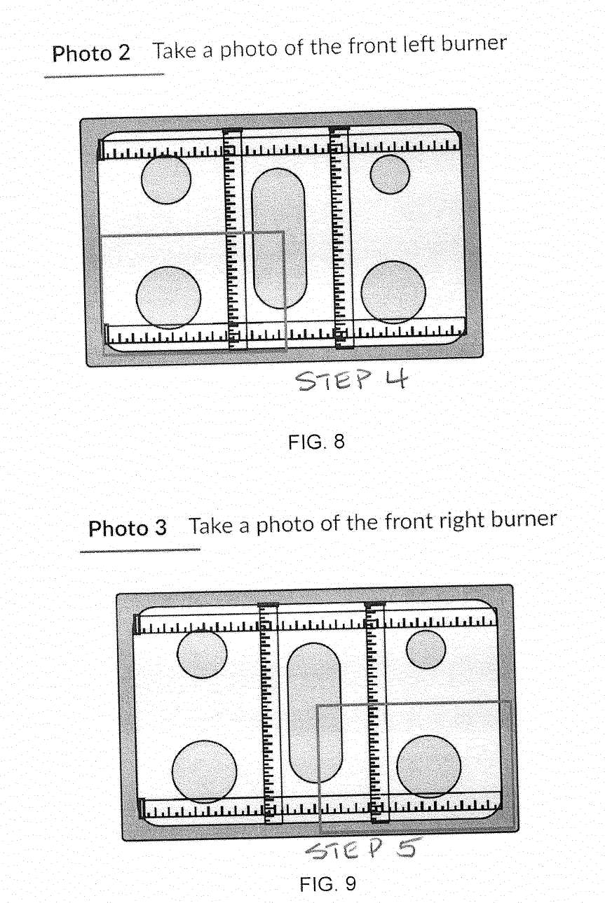

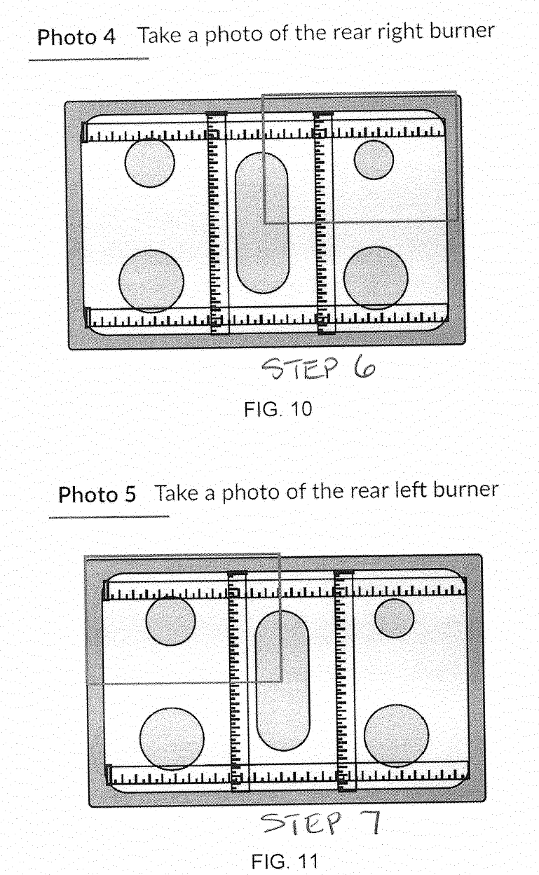

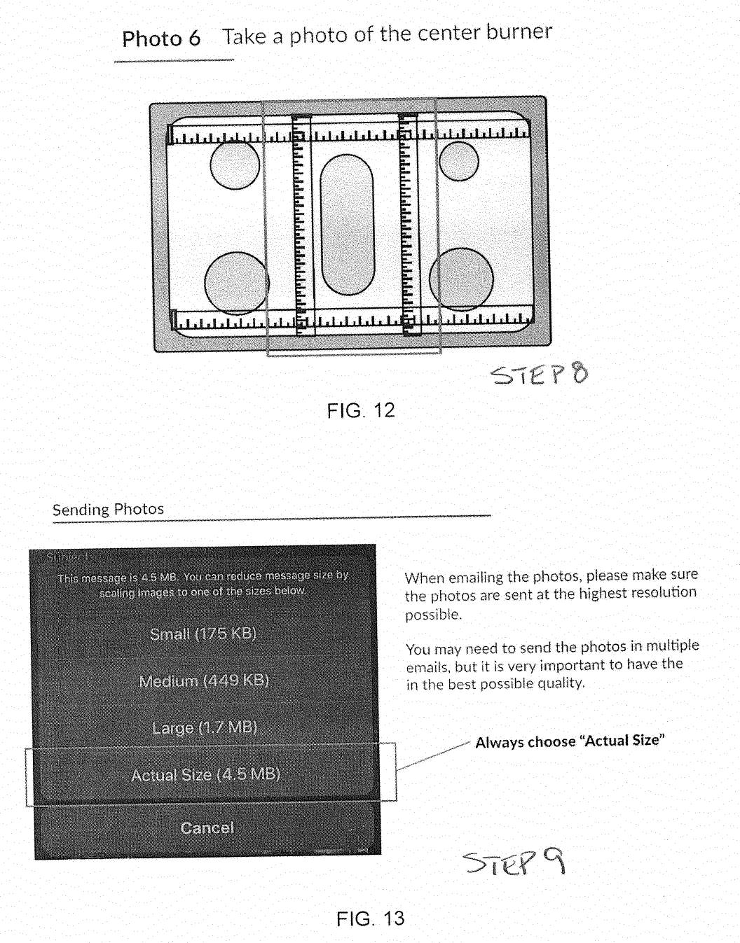

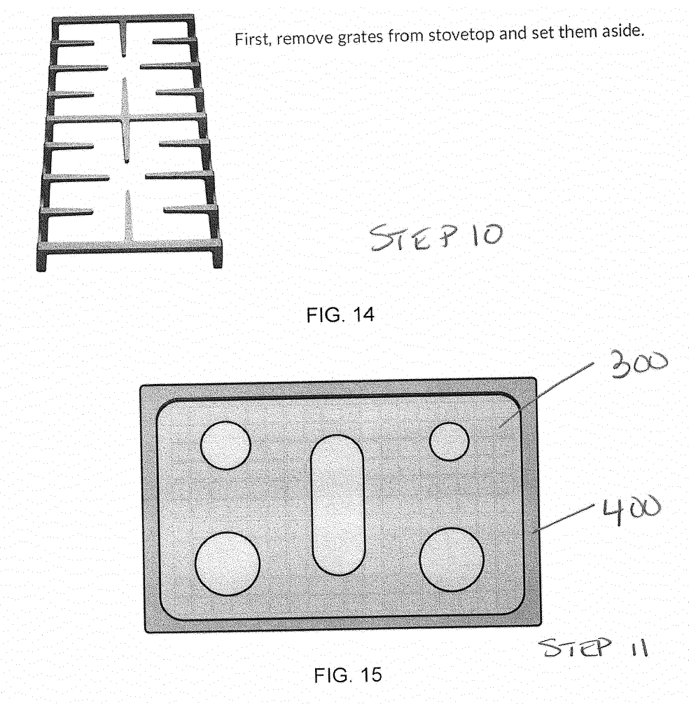

Referring now to FIG. 7 through FIG. 12, the remaining steps for the method for measuring custom fit stove top covers is shown. In STEP 3 through STEP 8 the user may take use a camera or smart phone having a camera function to acquire pictures of the stove top having the measuring tapes in place. The user may take five (5) photos, including of the entire stove top (STEP 3), the front left burner (STEP 4), the front right burner (STEP 5), the right rear burner (STEP 6), the rear left burner (STEP 7) and the center burner (STEP 8). It is preferred, but not essential, that the images be taken as level as possible.

Referring now to FIG. 13, the user then sends the photos by one or more emails to the manufacturer (STEP 9) with resolution as “actual size” and at the highest resolution possible. The user may alternately include an image of the stove model number tag, if available, normally found on the top edge of the door or top edge of a broiler drawer. When all the images are emailed, a paper cutout “proof” may be generated and forwarded to the user.

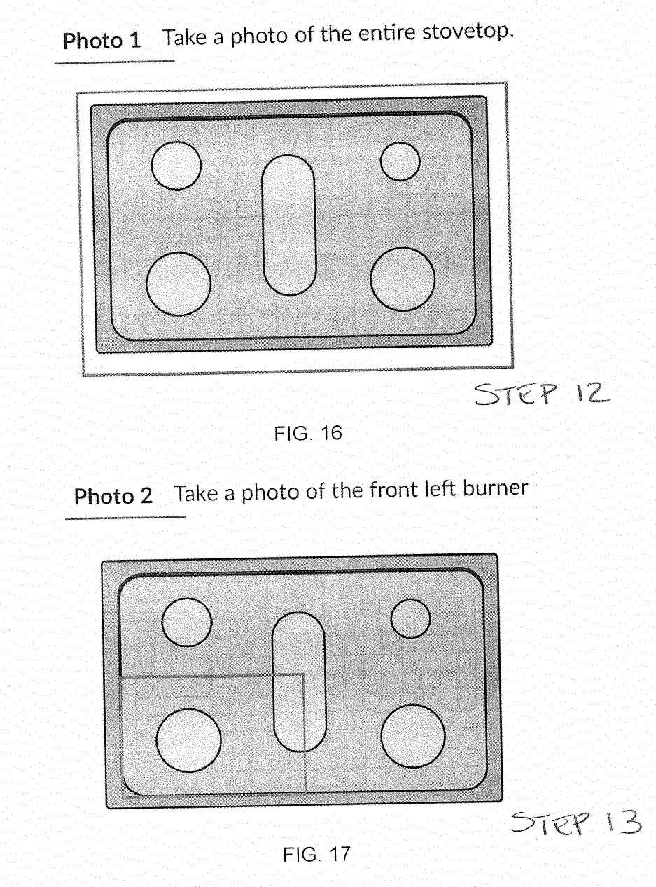

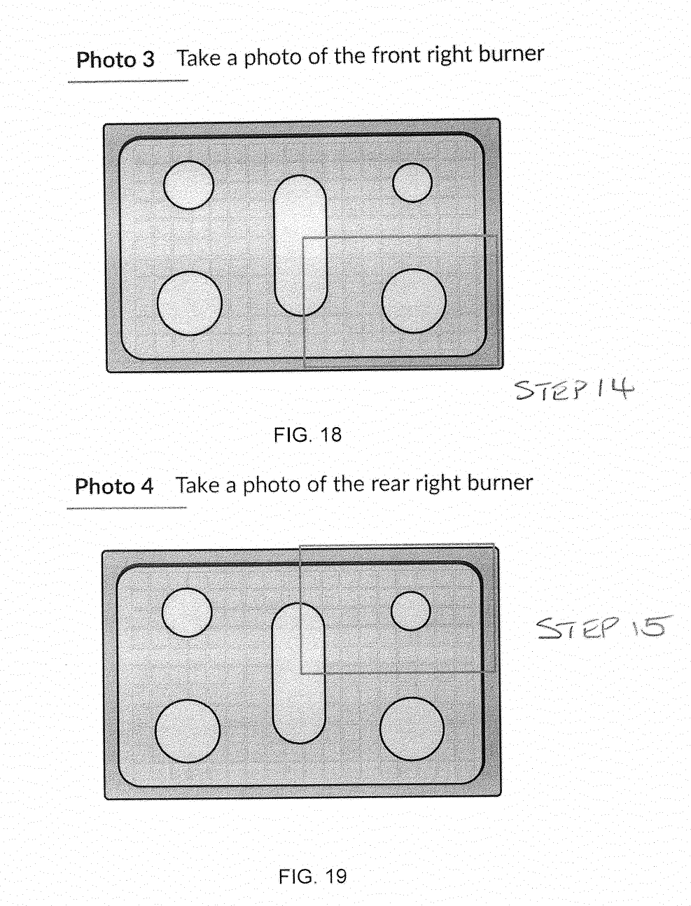

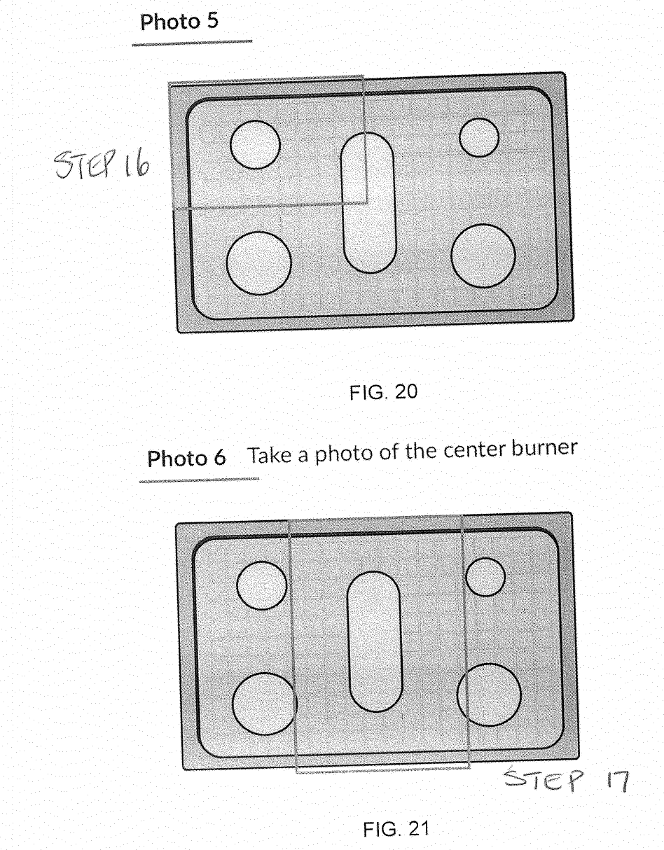

A paper proof 300 is thereby created (FIG. 4) and forwarded to the use. Once the user receives the proof 300, as shown in FIG. 15 through FIG. XX the user again removes the grates (STEP 10) and place the paper proof 300 onto the stove 400 (STEP 11) by unrolling the paper proof and placing on the stovetop. As shown in conjunction with FIG. 16 through FIG. 21. The user then uses the camera or cell pone to take pictures, repeating STEP 3 through STEP 8, namely, the user may take five (5) additional photos with paper proof 300 in place, including of the entire stove top (STEP 12), the front left burner (STEP 13), the front right burner (STEP 14), the right rear burner (STEP 15), the rear left burner (STEP 16) and the center burner (STEP 17). It is preferred, but not essential, that the images be taken as level as possible.

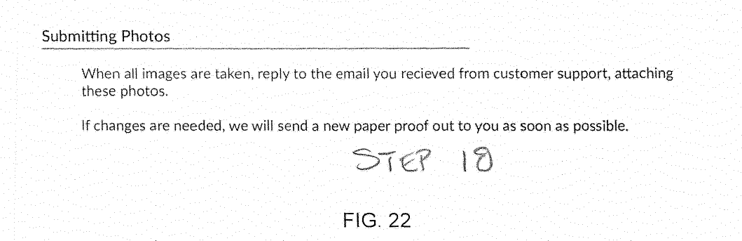

Referring now to FIG. 22, the user then sends the second grouping of five (5) images by one or more emails to the manufacturer (STEP 18) with resolution as “actual size” and at the highest resolution possible.

With final images of the paper proof 300 in place, the manufacturer may then manufacture the stove top cover in a manner that is custom fitted to the selected stove top, using the final five (5) images in order to make final adjustments that may be needed as shown between the paper proof 300 and the selected stove top. The final custom manufactured stove top cover may be then shipped to the user in a package, where the package may have overall dimensions not to exceed 18 inches by 14 inches by 8 inches.

What have been described above are examples. It is, of course, not possible to describe every conceivable combination of components or methods, but one of ordinary skill in the art will recognize that many further combinations and permutations are possible. Accordingly, the disclosure is intended to embrace all such alterations, modifications, and variations that fall within the scope of this application, including the appended claims. Thus, a stove top cover can be fabricated to accommodate different makes and models of stove tops to account for different stove top sizes, number of burners, type of burners, and the like.

Additionally, where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, and the term “including” means including but not limited to. The term “based on” means based at least in part on.

The foregoing descriptions of specific embodiments of the present invention are presented for purposes of illustration and description. The Title, Background, Summary, Brief Description of the Drawings and Abstract of the disclosure are hereby incorporated into the disclosure and are provided as illustrative examples of the disclosure, not as restrictive descriptions. It is submitted with the understanding that they will not be used to limit the scope or meaning of the claims. In addition, in the Detailed Description, it can be seen that the description provides illustrative examples and the various features are grouped together in various embodiments for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the Detailed Description, with each claim standing on its own as a separately claimed subject matter.

The claims are not intended to be limited to the aspects described herein, but is to be accorded the full scope consistent with the language claims and to encompass all legal equivalents. Notwithstanding, none of the claims are intended to embrace subject matter that fails to satisfy the requirement of 35 U.S.C. §101, 102, or 103, nor should they be interpreted in such a way. Any unintended embracement of such subject matter is hereby disclaimed. They are not intended to be exhaustive nor to limit the invention to precise forms disclosed and, obviously, many modifications and variations are possible in light of the above teaching. The embodiments are chosen and described in order to best explain principles of the invention and its practical application, to thereby enable others skilled in the art to best utilize the invention and its various embodiments with various modifications as are suited to the particular use contemplated. It is intended that a scope of the invention be defined broadly by the Drawings and Specification appended hereto and to their equivalents. Therefore, the scope of the invention is in no way to be limited only by any adverse inference under the rulings of Warner-Jenkinson Company, v. Hilton Davis Chemical, 520 US 17 (1997) or Festo Corp. v. Shoketsu Kinzoku Kogyo Kabushiki Co., 535 U.S. 722 (2002), or other similar caselaw or subsequent precedent should not be made if any future claims are added or amended subsequent to this Patent Application.

What is claimed is:

1. A method for measuring for the manufacture of custom fit stove top covers comprising the steps:
providing a measuring kit formed of at least one pliable measuring implement having visually identifiable sizing indicia;
placing the measuring kit on top of a selected stove top in a manner where the visually identifiable sizing indicia is positioned upward, wherein the at least one measuring implement is coordinated to an identifiable landmark of the stove top;
creating at least one image of the stove top having the measuring kit placed on top of and positioned thereon;
transmitting the at least one image to a manufacturer of a stove top cover;
creating a planar measuring proof of a stove top cover silhouette formed in the shape of a stove top cover and sized to custom fit stove the selected stove top;
placing the measuring proof on top of the selected stove top, wherein the measuring proof is coordinated to the identifiable landmark of the stove top;
creating at least a second image of the stove top having the measuring proof placed on top of and positioned thereon;
transmitting the at least one second image to the manufacturer of a stove top cover;
manufacturing the stove top cover to a custom fit to the selected stove top based upon the at least one second image; and
delivering a custom manufactured stove top cover to the user.

2. The method of claim 1, wherein said measuring kit comprises a plurality of flexible measuring tapes.

3. The method of claim 2, wherein said measuring kit comprises a set of four (4) flexible measuring tapes.

4. The method of claim 3, wherein placing the measuring kit on top of a selected stove top further comprises:
placing one flexible measuring tape along horizontally along a proximal edge of the stove top;
placing one flexible measuring tape along horizontally along a distal edge of the stove top; and
placing two flexible measuring tapes perpendicular to the horizontally placed measuring tapes;
wherein a position and a size of a stove top outline an at least one burner cutouts are identified to scale.

5. The method of claim 4, wherein the creating at least one image of the stove top having the measuring kit placed on top of and positioned thereon comprises:
creating an image of the entire stove top having the measuring kit placed on top; and
created an image of each portion of the stove top encompasing a burner having the measuring kit placed on top.

6. The method of claim 1, wherein the planar measuring proof is formed of a material selected from a group consisting of: translucent or transparent paper;
opaque paper; translucent or transparent plastic; and opaque plastic.

7. The method of claim 6, wherein the creating at least second image of the stove top having the measuring proof placed on top of and positioned thereon comprises:
creating an image of the entire stove top having the measuring proof placed on top; and
created an image of each portion of the stove top encompassing a burner having the measuring proof placed on top.

8. A custom fit stove top cover configured to engage a stove top and manufactured from a size and shape obtained from the method of claim 1, the custom fit stove top cover comprising:
a top surface;
a bottom surface;
a border coupled to the top surface that extends around an outer perimeter of the cover and projects outwardly from the top surface;
a cutout extending through the top surface and the bottom surface having a periphery that defines the cutout, wherein the cutout is configured to surround a burner of the stove top; and
a plurality of cutouts, wherein each is configured to surround one of a plurality of burners of the stove top;
wherein at least a portion of the cover comprises one or more of a fire retardant material, a fire resistant material, and a heat resistant material defining at least a portion of the cover as fire retardant, fire resistant material, and heat resistant.

9. A custom fit stove top cover configured to engage a stove top and manufactured from a size and shape obtained from the method of claim 2, the custom fit stove top cover comprising:
a top surface;
a bottom surface;
a border coupled to the top surface that extends around an outer perimeter of the cover and projects outwardly from the top surface;
a cutout extending through the top surface and the bottom surface having a periphery that defines the cutout, wherein the cutout is configured to surround a burner of the stove top; and
a plurality of cutouts, wherein each is configured to surround one of a plurality of burners of the stove top;
wherein at least a portion of the cover comprises one or more of a fire retardant material, a fire resistant material, and a heat resistant material defining at least a portion of the cover as fire retardant, fire resistant material, and heat resistant.

10. A custom fit stove top cover configured to engage a stove top and manufactured from a size and shape obtained from the method of claim 3, the custom fit stove top cover comprising:
a top surface;
a bottom surface;
a border coupled to the top surface that extends around an outer perimeter of the cover and projects outwardly from the top surface;
a cutout extending through the top surface and the bottom surface having a periphery that defines the cutout, wherein the cutout is configured to surround a burner of the stove top; and
a plurality of cutouts, wherein each is configured to surround one of a plurality of burners of the stove top;
wherein at least a portion of the cover comprises one or more of a fire retardant material, a fire resistant material, and a heat resistant material defining at least a portion of the cover as fire retardant, fire resistant material, and heat resistant.

11. A custom fit stove top cover configured to engage a stove top and manufactured from a size and shape obtained from the method of claim 4, the custom fit stove top cover comprising:
a top surface;
a bottom surface;
a border coupled to the top surface that extends around an outer perimeter of the cover and projects outwardly from the top surface;
a cutout extending through the top surface and the bottom surface having a periphery that defines the cutout, wherein the cutout is configured to surround a burner of the stove top; and
a plurality of cutouts, wherein each is configured to surround one of a plurality of burners of the stove top;
wherein at least a portion of the cover comprises one or more of a fire retardant material, a fire resistant material, and a heat resistant material defining at least a portion of the cover as fire retardant, fire resistant material, and heat resistant.

12. A custom fit stove top cover configured to engage a stove top and manufactured from a size and shape obtained from the method of claim 5, the custom fit stove top cover comprising:
a top surface;
a bottom surface;
a border coupled to the top surface that extends around an outer perimeter of the cover and projects outwardly from the top surface;
a cutout extending through the top surface and the bottom surface having a periphery that defines the cutout, wherein the cutout is configured to surround a burner of the stove top; and
a plurality of cutouts, wherein each is configured to surround one of a plurality of burners of the stove top;
wherein at least a portion of the cover comprises one or more of a fire retardant material, a fire resistant material, and a heat resistant material defining at least a portion of the cover as fire retardant, fire resistant material, and heat resistant.

13. A custom fit stove top cover configured to engage a stove top and manufactured from a size and shape obtained from the method of claim 6, the custom fit stove top cover comprising:
a top surface;
a bottom surface;
a border coupled to the top surface that extends around an outer perimeter of the cover and projects outwardly from the top surface;
a cutout extending through the top surface and the bottom surface having a periphery that defines the cutout, wherein the cutout is configured to surround a burner of the stove top; and
a plurality of cutouts, wherein each is configured to surround one of a plurality of burners of the stove top;
wherein at least a portion of the cover comprises one or more of a fire retardant material, a fire resistant material, and a heat resistant material defining at least a portion of the cover as fire retardant, fire resistant material, and heat resistant.

14. A custom fit stove top cover configured to engage a stove top and manufactured from a size and shape obtained from the method of claim 7, the custom fit stove top cover comprising:
a top surface;
a bottom surface;
a border coupled to the top surface that extends around an outer perimeter of the cover and projects outwardly from the top surface;
a cutout extending through the top surface and the bottom surface having a periphery that defines the cutout, wherein the cutout is configured to surround a burner of the stove top; and
a plurality of cutouts, wherein each is configured to surround one of a plurality of burners of the stove top;
wherein at least a portion of the cover comprises one or more of a fire retardant material, a fire resistant material, and a heat resistant material defining at least a portion of the cover as fire retardant, fire resistant material, and heat resistant.

15. The method of claim 1, wherein delivering the custom manufactured stove top cover to the user comprises shipping the stove top cover in a package having overall dimensions not to exceed 18 inches by 14 inches by 8 inches.

16. The custom fit stove top cover of 8, wherein delivering the custom manufactured stove top cover to the user comprises shipping the stove top cover in a package having overall dimensions not to exceed 18 inches by 14 inches by 8 inches.

17. The custom fit stove top cover of 10, wherein delivering the custom manufactured stove top cover to the user comprises shipping the stove top cover in a package having overall dimensions not to exceed 18 inches by 14 inches by 8 inches.

18. The custom fit stove top cover of 12, wherein delivering the custom manufactured stove top cover to the user comprises shipping the stove top cover in a package having overall dimensions not to exceed 18 inches by 14 inches by 8 inches.

19. The custom fit stove top cover of 14, wherein delivering the custom manufactured stove top cover to the user comprises shipping the stove top cover in a package having overall dimensions not to exceed 18 inches by 14 inches by 8 inches.
